(19) United States
(12) Patent Application Publication
(10) Pub. No.: US 2024/0069171 A1
(43) Pub. Date: Feb. 29, 2024

(54) VERTICAL BEAM STEERING WITH A MEMS PHASED-ARRAY FOR LIDAR APPLICATIONS

(71) Applicants: Silicon Light Machines Corporation, San Jose, CA (US); SCREEN Holdings Co., Ltd., Kyoto-shi, Kyoto (JP)

(72) Inventors: Yuki ASHIDA, Kyoto (JP); Stephen Sanborn HAMANN, Mountain View, CA (US)

(21) Appl. No.: 18/453,160

(22) Filed: Aug. 21, 2023

Related U.S. Application Data
(60) Provisional application No. 63/400,178, filed on Aug. 23, 2022.

(51) Int. Cl. G01S 7/481; G01S 17/931

(52) U.S. Cl. CPC G01S 7/4817; G01S 7/4816; G01S 17/931

(57) ABSTRACT

A light detection and ranging (LIDAR) system incorporates a scanning system with random access pointing. The scanning system has a light source that generates a coherent light, a micro-electro-mechanical system (MEMS) phased-array that steers the coherent light in a vertical direction, and a resonant scanner that scans the coherent light in a horizontal direction. The coherent light is projected onto a far field scene. The MEMS phased-array steers the coherent light to point the projected light on selected spots on the far field scene in random access fashion.

### CROSS-REFERENCE TO RELATED APPLICATION

This application claims the benefit of U.S. Provisional Application No. 63/400,178, filed on Aug. 23, 2022, which is incorporated herein by reference in its entirety.

### TECHNICAL FIELD

The present disclosure is generally directed to scanning systems, and more particularly to light detection and ranging (LIDAR) systems.

### BACKGROUND

LIDAR systems are widely used for mapping, object detection and identification, and navigation in a number of different applications including Advanced Driver-Assistance Systems (ADAS), autonomous vehicles, robotics, etc. Generally, a LIDAR system works by illuminating a target in a far field scene with coherent light from a light source, typically a laser, and detecting the return light with a sensor. Differences in light return times and wavelengths are analyzed by the LIDAR system to measure a distance to the target and, in some applications, to render a digital 3-D representation of the target in the form of point clouds.

Traditional LIDAR systems employ a mechanical scanner, such as a spinning or moving mirror, to scan the light beam onto the target. However, these mechanical scanners are rather bulky and relatively expensive, making them unsuitable for many applications.

A more recent technology is solid state LIDAR systems in which the scanner is replaced by micro-electro-mechanical system (MEMS) phased-array comprising MEMS-based spatial light modulators (SLMs). U.S. Patent Publication No. US 2021/0072531 A1, filed on Aug. 24, 2020, titled “MEMS PHASED-ARRAY FOR LIDAR APPLICATIONS”, discloses example usage of a MEMS phased-array in LIDAR systems.

An example MEMS-based SLM is the Grating Light Valve (GLV®) device, which is commercially-available from Silicon Light Machines, Inc. The GLV® device is a well-known ribbon-type SLM. Briefly, a ribbon-type SLM may be arranged as a one-dimensional (1-D) phased-array comprising a plurality of ribbons that are employed as modulation elements. A ribbon includes a reflective surface that may be actuated to deflect vertically through a gap or cavity toward a substrate when a voltage is applied between an electrode of the ribbon and a base electrode formed in or on the substrate. The ribbons are capable of being addressed individually for actuation. Steering is achieved by actuating the ribbons to reflect or diffract light incident thereon.

Another example MEMS-based SLM is the Planar Light Valve device, which is also a well-known device commercially-available from Silicon Light Machines, Inc. The Planar Light Valve device, which comprises a two-dimensional array of pixels as modulation elements, is a two-dimensional (2-D) equivalent of the 1-D GLV® device. The 2-D pixel arrangement enables larger pixel counts for continued throughput enhancement.

### BRIEF SUMMARY

In one embodiment, a LIDAR system incorporates a scanning system with random access pointing. The scanning system has a light source that generates coherent light, a MEMS phased-array that steers the coherent light in a vertical direction, and a resonant scanner that scans the coherent light at a resonant frequency in a horizontal direction. The coherent light is projected onto a far field scene. The MEMS phased-array steers the coherent light to point the projected light on selected spots on the far field scene in random access fashion. Return light from the far field scene may be received by one or more detectors in monostatic or bistatic configuration.

These and other features of the present disclosure will be readily apparent to persons of ordinary skill in the art upon reading the entirety of this disclosure, which includes the accompanying drawings and claims.

### BRIEF DESCRIPTION OF THE DRAWINGS

A more complete understanding of the subject matter may be derived by referring to the detailed description and claims when considered in conjunction with the following figures, wherein like reference labels refer to similar elements throughout the figures. The figures are not drawn to scale.

FIG. 1 is a schematic top view of a 1-D phased-array that may be employed as a MEMS phased-array in embodiments of the present invention.

FIG. 2 is a schematic cross-sectional view of a ribbon taken along section A-A of FIG. 1.

FIGS. 3 and 4 are schematic phased-array axis views that illustrate a general operation of a MEMS phased-array comprising ribbon-type SLMs.

FIG. 5 is a schematic diagram of a scanning system, in accordance with an embodiment of the present invention.

FIGS. 6A and 6B pictorially illustrate an example application of random access pointing, in accordance with an embodiment of the present invention.

FIGS. 7A and 7B pictorially illustrate another example application of random access pointing, in accordance with an embodiment of the present invention.

FIGS. 8A-8D pictorially illustrate steering and axial scanning using a lensing effect of a MEMS phased-array of the scanning system of FIG. 5, in accordance with an embodiment of the present invention.

FIGS. 9A and 9B pictorially illustrate the difference between fixed vertical scanning angular resolution and variable vertical scanning angular resolution.

FIGS. 10A and 10B pictorially illustrate beam splitting, in accordance with an embodiment of the present invention.

FIG. 11A is a schematic diagram of the scanning system of FIG. 5, with the modulation elements of the MEMS phased-array modulated into a standard blazed steering pattern.

FIG. 11B is a schematic diagram of the scanning system of FIG. 5, with the modulation elements of the MEMS phased-array modulated into a blazed steering pattern with binary phase grating pattern.

FIG. 11C pictorially illustrate a use case where a LIDAR system that incorporates the scanning system of FIG. 5 may receive return light from retroreflectors on the road, in accordance with an embodiment of the present invention.

FIGS. 12A, 12B, 13A, and 13B pictorially illustrate the scanning system of FIG. 5 being configured to adjust horizontal field of view for different driving conditions, in accordance with embodiments of the present invention.

FIGS. 14A and 14B are schematic diagrams of the scanning system of FIG. 5 configured for monostatic configuration, in accordance with an embodiment of the present invention.

FIGS. 15A, 15B, and 15C are schematic diagrams of the scanning system of FIG. 5 configured for bistatic configuration, in accordance with an embodiment of the present invention.

FIGS. 16A and 16B are schematic diagrams of a scanning system, in accordance with another embodiment of the present invention.

FIGS. 17-19 schematically illustrate receiver configurations that may be employed in the scanning system of FIGS. 16A and 16B, in accordance with embodiments of the present invention.

FIG. 20 is a flow diagram of a method of operation of a LIDAR system, in accordance with an embodiment of the present invention.

### DETAILED DESCRIPTION

In the present disclosure, numerous specific details are provided, such as examples of systems, materials, components, and methods, to provide a thorough understanding of embodiments of the invention. Persons of ordinary skill in the art will recognize, however, that the invention can be practiced without one or more of the specific details. In other instances, well-known details are not shown or described to avoid obscuring aspects of the invention.

Use cases of embodiments of the present invention are explained in the context of an automobile travelling along roads for illustration purposes. It is to be noted, however, that the embodiments are equally applicable to other LIDAR use cases, including ADAS and other sensing systems on manned or autonomous aircrafts, watercrafts, spacecrafts, drones, and vehicles in general.

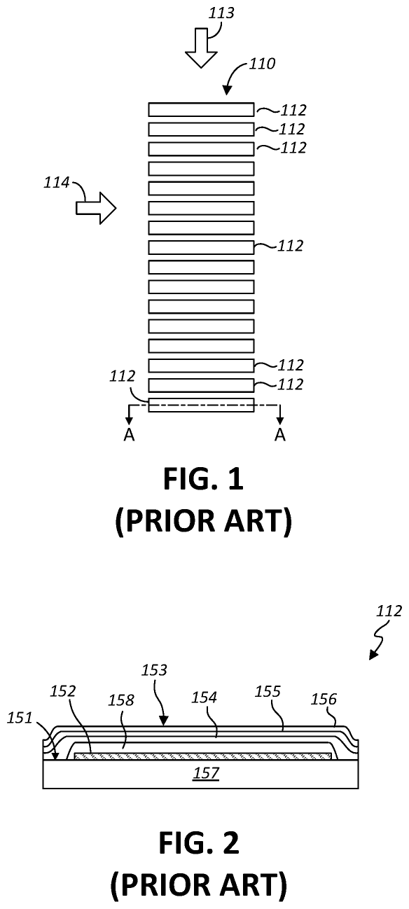

FIG. 1 is a schematic top view of a 1-D phased-array 110 that may be employed as a MEMS phased-array in embodiments of the present invention. In one embodiment, the phased-array 110 is the Grating Light Valve (GLV®) device commercially-available from Silicon Light Machines, Inc. As can be appreciated, embodiments of the present invention are equally applicable to other types of MEMS-based SLMs. For example, embodiments of the present invention may be adapted to planar-type SLMs, such as the Planar Light Valve device commercially-available from Silicon Light Machines, Inc.

The phased-array 110 comprises a plurality of modulation elements, which in the example of FIG. 1 are a plurality of addressable electrostatically actuated ribbons 112. The phased-array 110 may have thousands of ribbons 112 but only a few are shown and labeled for clarity of illustration. It is to be noted that the ribbons 112 may be arranged and controlled in groups, and one or more ribbons 112 in a group may be in a fixed position (i.e., not movable) relative to other ribbons 112 in the group. Actuation of the ribbons 112 is controlled by drive signals from a drive controller (not shown). The long axis of ribbon view is as seen in the direction of arrow 113, and the phased-array axis view is as seen in the direction of arrow 114.

FIG. 2 is a schematic cross-sectional view of a ribbon 112 taken along section A-A of FIG. 1. In the example of FIG. 2, a ribbon 112 includes a reflective layer 156 that has a reflective surface 153. An elastic mechanical layer 154 supports the reflective layer 156 above the surface 151 of a substrate 157. An electrode 155 is deflectable through a gap or cavity 158 toward the substrate 157 by electrostatic forces generated when a voltage is applied between the electrode 155 and a base electrode 152 formed in or on the substrate 157.

The mechanical layer 154 may comprise a taut silicon-nitride film (SiNx), and flexibly supported above the surface 151 of the substrate 157 by a number of posts or structures, typically also made of SiNx, at both ends of the ribbon 112. The reflective layer 156 may comprise a suitable metallic, dielectric, or semiconducting material compatible with standard MEMS fabrication technologies, and capable of being patterned using standard lithographic techniques to form the reflective surface 153. The electrode 155, which is an electrically conducting layer, may be formed over and in direct physical contact with the mechanical layer 154 as shown, or underneath the mechanical layer 154. The electrode 155 may be a conducting or semiconducting material compatible with standard MEMS fabrication technologies. For example, the electrode 155 may comprise a doped polycrystalline silicon layer or a metal layer. Alternatively, if the reflective layer 156 is metallic, the reflective layer 156 may also serve as the electrode 155.

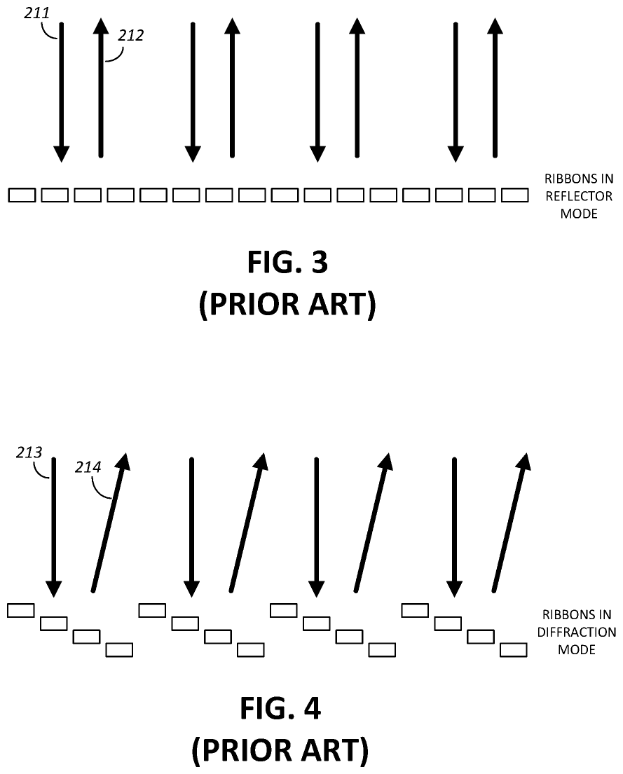

FIGS. 3 and 4 are schematic phased-array axis views that illustrate a general operation of a MEMS phased-array comprising ribbon-type SLMs. Modulation elements, such as ribbons, may be operated in groups of two or more. FIGS. 3 and 4 show ribbons operating in groups of four for illustration purposes.

A ribbon-type SLM operates as a reflector when all of the ribbons are in quiescent state and as a diffraction grating when the ribbons are in varying levels of deflection. That is, a group of ribbons may operate in reflector mode or diffraction mode. A group of ribbons operate in reflector mode when all of the ribbons in the group are at the same distance relative to the surface of the substrate, such as when all of the ribbons in the group are in the quiescent state. FIG. 3 shows the groups of ribbons in reflector mode. In the reflector mode, incident light (see FIG. 3, 211) is reflected back toward the light source (see FIG. 3, 212).

A group of ribbons operates in diffraction mode when the ribbons in the group are at varying distances relative to the surface of the substrate. One or more ribbons may be separately addressable to deflect a certain distance from the surface of the substrate to form a modulation pattern in accordance with a drive signal from a drive controller. FIG. 4 shows groups of ribbons in diffraction mode. In diffraction mode, incoming light (see FIG. 4, 213) incident on the ribbons is diffracted, thereby changing the angle of the outgoing light (see FIG. 4, 214).

A ribbon-type SLM is capable of near-infrared scanning (NIR) up to 1550 nm wavelength, with over 100 kHz point to point refresh rates. As will be more apparent below, embodiments of the present invention operate MEMS-based phased arrays to point the projected light on the far field scene in random access fashion. Embodiments of the present invention thus allow a LIDAR system to dynamically select particular regions to be sensed and dynamically adjust the amount of data points that can be sensed.

LIDAR systems in automotive and other vehicular applications benefit from a non-linear vertical resolution. For example, the most important region of interest for an automobile (e.g., car or truck) travelling along a flat road is the center, where many data points are collected to look for in-plane hazards. The next most important region is downwards, to look for hazards along the ground. The least important region for flat travel is upwards because hazards usually do not come from the sky in normal automotive use.

Mechanical mirror scanners or MEMS mirror scanners are either too slow or must move symmetrically around a center of resonance. Typical LIDAR systems that are based on these mirror scanners must rely on sparser point clouds or oversample regions of less importance within a typical vertical field of view (FOV) (40°, +/−20°). Mirror scanners in the linear regime are slow and will generally have a fixed resolution over the FOV. However, a resonant mirror scanner may be fast and may have the ability to restrict or extend the FOV by changing the drive amplitude. Still, mirror scanners have issues with pointing stability and will oversample edges of the FOV in a Lissajous type pattern. Even when these issues are overcome, the FOV of resonant mirror scanners can only be expanded around a fixed center with symmetric resolution.

In one embodiment, a MEMS phased-array, such as the phased-array 110 of FIG. 1, is controlled to modify the resolution and timing of a scan to create an arbitrary point cloud configuration to match road conditions. Generally, basic steering of incident light on the MEMS phased-array is achieved by deflecting the ribbons into a linear phase pattern commonly known as a blazed grating or phase ramp. The slope of the phase ramp is determined by the pixel pitch of the ribbons and wavelength of the light source. The MEMS phased-array may also be used as a full phase modulator, allowing for additional effects beyond random access pointing, such as 1-D lensing, aberration correction, and amplitude control.

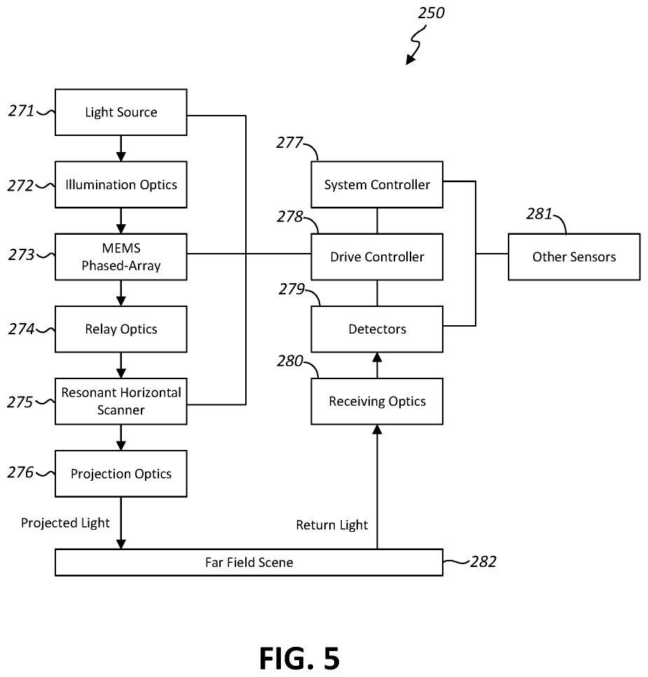

FIG. 5 is a schematic diagram of a scanning system 250, in accordance with an embodiment of the present invention. A LIDAR system may incorporate the scanning system 250 to scan a far field scene 282.

In the example of FIG. 5, a light source 271 (e.g., laser source) generates coherent light. Illumination optics 272 is disposed along a light path between the light source 271 and a MEMS phased-array 273. The illumination optics 272 illuminates the MEMS phased-array 273 with light generated by the light source 271.

The MEMS phased-array 273 serves as a vertical scanner of the scanning system 250. In one embodiment, the MEMS phased-array 273 is a ribbon-type SLM, such as the phased-array 110 of FIG. 1. That is, in one embodiment, the MEMS phased-array 273 has ribbons as modulation elements. The MEMS phased-array 273 steers the light generated by the light source 271 in a vertical direction onto the far field scene 282 by way of the resonant horizontal scanner 275 and the projection optics 276.

The relay optics 274 is disposed along a light path between the MEMS phased-array 273 and the resonant horizontal scanner 275. The relay optics 274 directs light steered by the MEMS phased-array 273 onto the resonant horizontal scanner 275.

The resonant horizontal scanner 275 may be a resonant mechanical mirror or resonant MEMS mirror, for example. The resonant horizontal scanner 275 scans the light steered by the MEMS phased-array 273 in a horizontal direction at a resonant frequency onto the far field scene 282 by way of the projection optics 276.

The projection optics 276 is disposed along a light path between the resonant horizontal scanner 275 and the far field scene 282. The projection optics 276 projects the light scanned by the resonant horizontal scanner 275 onto the far field scene 282.

Receiving optics 280 directs return light from the far field scene 282 onto one or more detectors 279. The detectors 279 may comprise a 1-D array or 2-D array of photodetectors, such as a single-photon avalanche diode sensor (SPAD). The scanning system 250 may have additional (e.g., filter optics) or fewer optics depending on the application.

A drive controller 278 comprises an electrical circuit that is configured to generate drive signals that deflect the ribbon elements of the MEMS phased-array 273 into desired modulation patterns, to drive the resonant horizontal scanner 275 to scan in a horizontal direction at a resonant frequency, and to coordinate timing with a system controller 277, light source 271, and the detectors 279. The drive controller 278 may be implemented with discrete circuits, application-specific integrated circuit (ASIC), system on chip (SOC), microcontroller with associated software, etc.

As employed in a LIDAR system, the system controller 277 is configured to determine the desired modulation patterns of the ribbon elements of the MEMS phased-array 273 based on point clouds that are determined from the return light and other sensed data from other sensors 281 (e.g., camera, radar). The system controller 277 may process sensed data from the detectors 279 and from the other sensors 281 in accordance with conventional LIDAR algorithms to sense the far field scene 282 for navigation, object detection, ADAS, and/or other LIDAR uses. The system controller 277 may be implemented using a general purpose computer with associated software.

With no drive signal to the MEMS phased-array 273, the projected light would scan a single horizontal line on the far field scene 282. The drive signal to the MEMS phased-array 273 may be shaped to drive the ribbon elements of the MEMS phased-array 273 into a modulation pattern that steers the projected light to point from a first spot directly to a second spot without necessarily having to point at another spot in between thereby allowing for random access pointing on the far field scene 282. Random access pointing facilitates intelligent point cloud collection, in that important regions of the far field scene 282 may be sensed more relative to other regions.

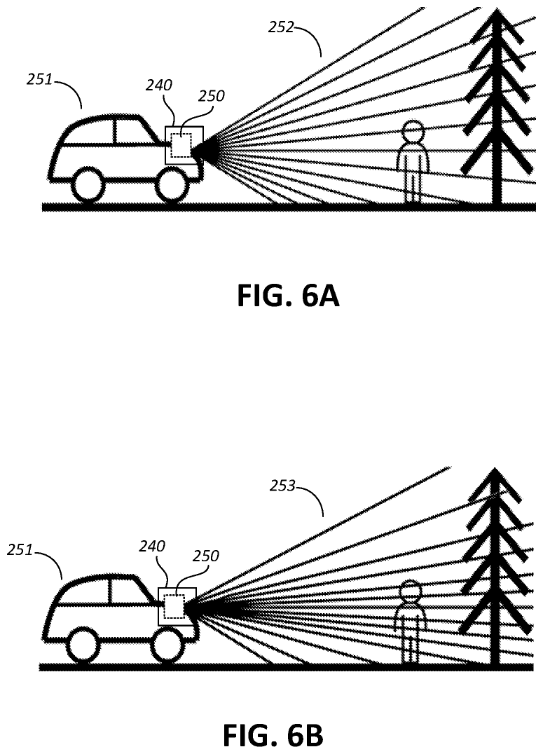

FIGS. 6A and 6B pictorially illustrate an example application of random access pointing, in accordance with an embodiment of the present invention. In the example of FIGS. 6A and 6B, a vehicle 251 is equipped with a LIDAR system 240 that has the scanning system 250. In FIG. 6A, the scanning system 250 scans (see lines 252) a far field scene in the direction of travel of the vehicle 251. In FIG. 6B, the vertical FOV and vertical resolution (see lines 253) of the scanning system 250 is adjusted to scan more of the middle region, relative to the upper region, of the far field scene. The vertical FOV and vertical resolution of the scanning system 250 may be adjusted by shaping the drive signal generated by the drive controller 278 to modulate the ribbon elements of the MEMS phased-array 273 into a pattern that steers the projected light to scan more of the middle region.

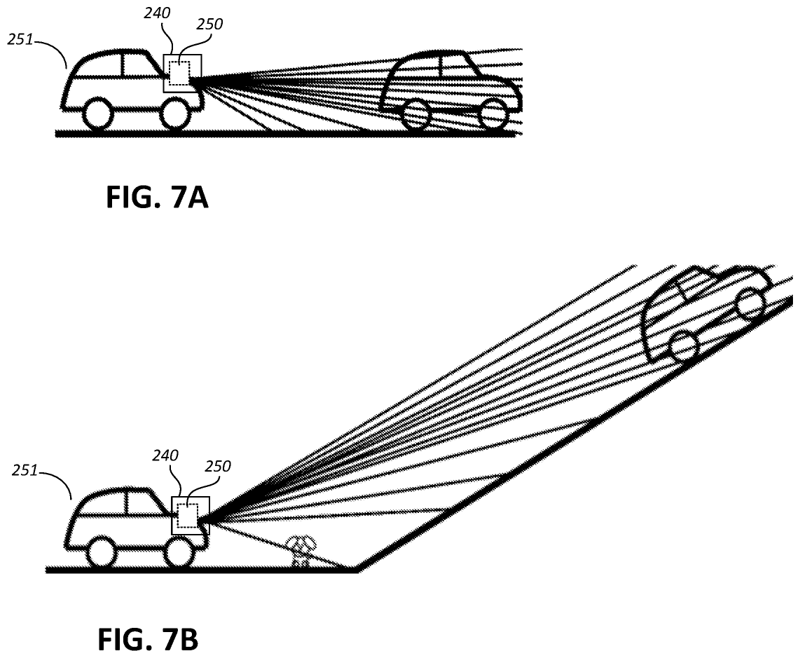

FIGS. 7A and 7B pictorially illustrate another example application of random access pointing, in accordance with an embodiment of the present invention. In the example of FIGS. 7A and 7B, the vehicle 251 is equipped with the LIDAR system 240 that has the scanning system 250. While travelling along a flat road, the region of interest is primarily along the horizontal plane of the direction of travel and secondarily toward the ground plane. That is to say, there is seldom a need to scan upwards while driving along a flat section of a freeway. Furthermore, the horizontal plane may have objects at a near or far distance (e.g., the next automobile in front of the vehicle 251 may be a few car lengths away or two hundred meters ahead), whereas scanning downwards will reflect projected light off the road at a generally predictable distance based on the height of the sensors of the scanning system 250.

Random access pointing allows for sampling the horizontal plane more times while travelling along a flat section of the freeway due to the higher likelihood of important objects being on the same plane as the vehicle 251, the increased unpredictably of the position of these objects, and the fact that farther objects, which are more likely to be found on the plane of travel of the vehicle 251, will benefit from more interrogations due to the decreased return light compared to closer objects as illustrated in FIG. 7A. Other sensors 281 of the scanning system 250, such as cameras and radar, may also provide additional information so that the projected light is biased to sample more of the ground or sky depending on sensor fusion information. As an example, when the vehicle 251 approaches a hill, cameras, radar, and/or other sensors 281 of the scanning system 250 will detect the road gradient and, in response, cause the drive controller 278 to drive the MEMS phased-array 273 to effectively move the center of the system vertical FOV upwards to continue scanning for obstacles farther along the road as illustrated in FIG. 7B.

Adding a cylindrical and linear phase profile creates a lensing affect that allows for both steering and axial scanning, as described in J. R. Landry et al., “Random Access Cylindrical Lensing and Beam Steering Using a High-Speed Linear Phased Array,” in IEEE Photonics Technology Letters, vol. 32, no. 14, pp. 859-862, 15 Jul. 15, 2020. The lensing effect allows the MEMS phased-array to change the vertical far field diffraction angle of the projected beam.

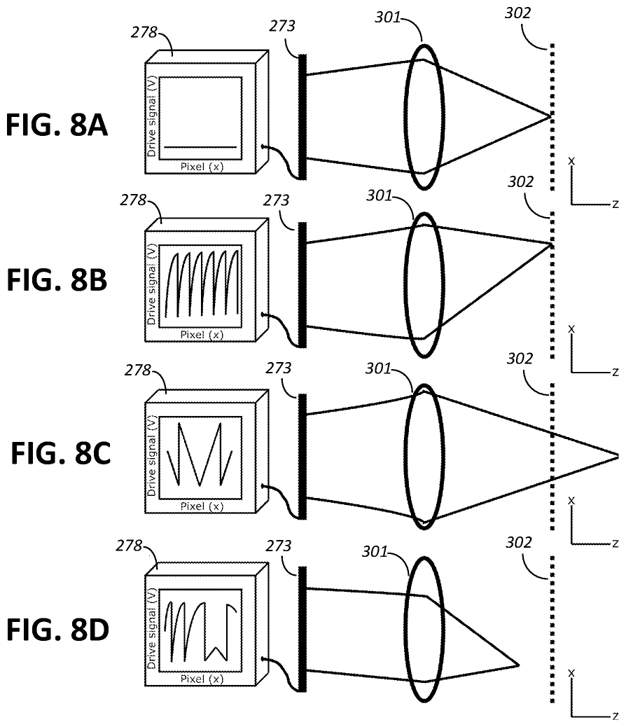

FIGS. 8A-8D pictorially illustrate steering and axial scanning by the lensing effect of the MEMS phased-array 273 of the scanning system 250, in accordance with an embodiment of the present invention. In FIGS. 8A-8D, a Fourier lens 301 is disposed along a light path between the MEMS phased-array 273 and the far field scene. The drive controller 278 is depicted with a waveform of the drive signal to the MEMS phased-array 273. The x-axis of the waveform indicates a “pixel” (i.e., modulation element) and the y-axis of the waveform indicates a corresponding voltage of the drive signal.

In FIG. 8A, the drive controller 278 does not generate a drive signal to the MEMS phased-array 273. This results in the light beam from the MEMS phased-array 273 being focused on the center of a nominal reference plane 302. FIGS. 8B-8D show the drive controller 278 generating drive signals that impart a combination of ramp and cylindrical phases to scan the light beam from the MEMS phased-array 273 upwards on the reference plane 302 (FIG. 8B), on the center but beyond the reference plane 302 (FIG. 8C), and below the center but before the reference plane 302.

The optical system of the scanning system 250 may be designed for the default diffraction angle to be smallest for the highest range situations, e.g., an autonomous vehicle travelling at highway speeds would want the light beam from the light source 271 to be collimated to optimize spot power at 200-300 m ahead. Imparting a positive focus on the light beam may enable a tighter diffraction angle, but the smallest angle will generally be dictated by the system aperture and cannot be improved much. However, the positive focus may correct for alignment errors and thus improve far field power. That is, lensing may fix alignment errors for better collimation, increasing far field power and therefore range. On the other hand, a negative cylindrical focus will diverge the light beam, causing the beam spot to diverge faster. This enlarged beam spot may be useful in situations where high resolution is less preferable to high speed, especially when the expected reflector is closer to the vehicle. As an example, a 0.1° spot will cover 35 cm at 200 m but only 3.5 mm at 20 m. This precision is most likely unnecessary at travelling speeds, and a 1° spot would have similar resolution at 20 m as the 0.1° spot at 200 m.

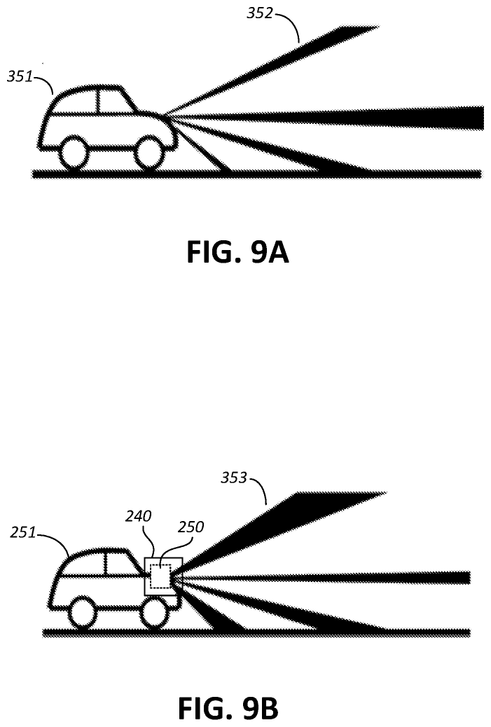

FIGS. 9A and 9B pictorially illustrate the difference between fixed vertical scanning angular resolution (FIG. 9A) and variable vertical scanning angular resolution (FIG. 9B). In FIG. 9A, a vehicle 351 is equipped with a LIDAR system comprising traditional mirror scanners in both the vertical and horizontal direction. The mechanical steering of the light beam (see 352) results in fixed angular resolution. In FIG. 9B, the vehicle 251 is equipped with the LIDAR system 240 comprising the scanning system 250. The MEMS phased-array 273 of the scanning system 250 allows for adjustment of vertical diffraction angle (see 353) by lensing effect to dynamically match road conditions.

Wide angle far field projection requires a wide angle lens, which often cause large aberrations. A common aberration is field distortion, which may greatly shift spots from their desired location. For barrel distortion, spots are greatly shifted towards the center and their diffraction angle will be slightly changed. This distortion may be measured as part of calibration and actively corrected using the MEMS phased-array. For a spot that is centered horizontally but skewed vertically, the MEMS phased-array may simply readjust the spot location by a predetermined angle. For a purely horizontal skew with a spot scan system, the high MEMS phased-array refresh rate enables fast switching that allows for variable pulse delay. The desired delay is determined by the skew amount and the secondary axis scan pattern. For spots that are skewed off of the central axes, a combination of vertical angle and timing delay may be used.

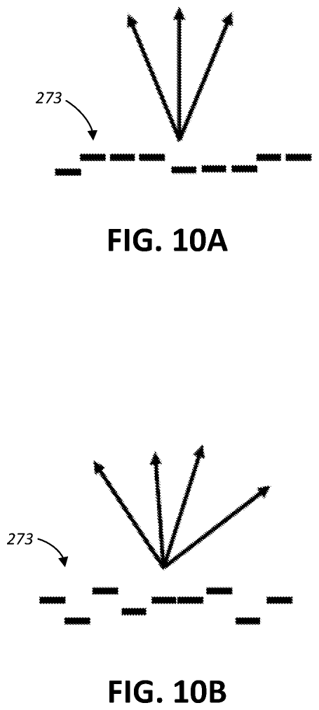

Full arbitrary phase control of a MEMS phased-array enables additional features other than random access pointing. For example, rather than scan a single beam, the MEMS phased-array may preferentially split the beam across multiple spots by introducing high period grating orders or by holographic optimization. FIGS. 10A and 10B pictorially illustrate beam splitting, in accordance with an embodiment of the present invention. Generally, the MEMS phased-array may create multiple vertical spots for LIDAR systems with 1-D detector arrays. In FIG. 10A, a simple grating pattern of the ribbon elements of the MEMS phased-array 273 creates spots at fixed locations. In FIG. 10B, full holographic optimization of the ribbon elements of the MEMS phased-array 273 creates arbitrarily placed spots.

Splitting the beam may be useful when less power is needed and there is a detector array to discriminate returns. Similarly, especially for single detector systems, the MEMS phased-array may divert additional light outside of its FOV, thereby dimming the projected beam. This technique may, for example, be used to increase eye safety when scanning near objects recognized as people or to squelch return light from retroreflective surfaces, which may be orders of magnitude stronger than diffusely reflective objects. Additionally, a shifting but known phase front may be used to mitigate scattering, such as off of fog or rain, using one dimensional ghost imaging by comparing the return light from the turbulent media to the predicted deviation in a non-turbulent media caused by the shift in the phase front.

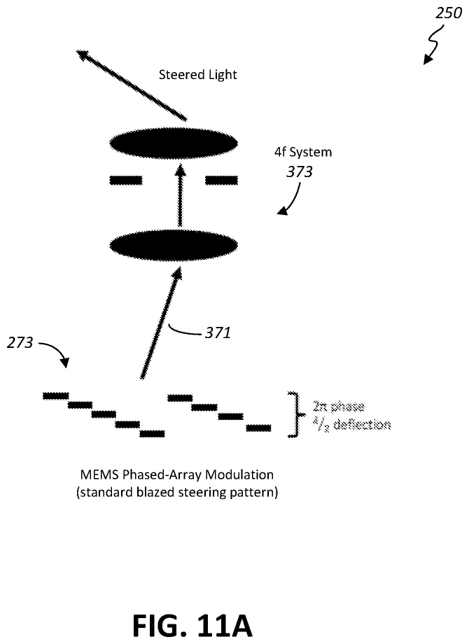

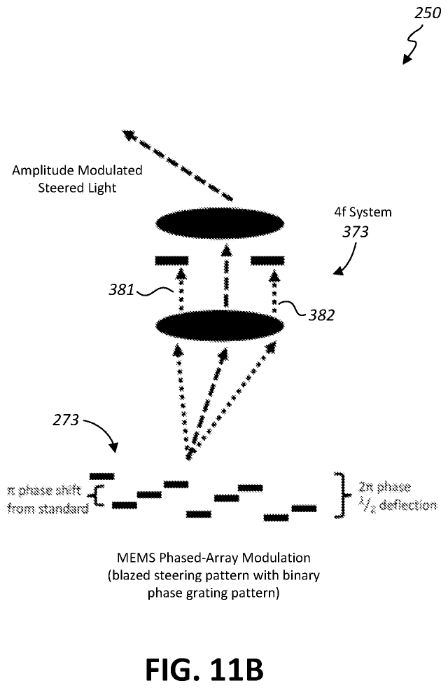

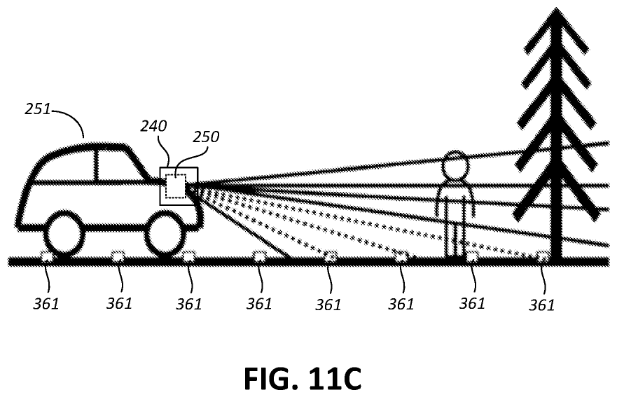

FIG. 11A is a schematic diagram of the scanning system 250, with the ribbon elements of the MEMS phased-array 273 modulated into a standard blazed steering pattern. Light beam from the MEMS phased-array 273 (see 371) passes through a 4f system 373. The 4f system 373 magnifies the steering angle and filters out first and higher order light.

FIG. 11B is a schematic diagram of the scanning system 250, with the ribbon elements of the MEMS phased-array 273 modulated into a blazed steering pattern with binary phase grating pattern. As in FIG. 11A, the 4f system 373 in FIG. 11B magnifies the steering angle and filters out first and higher order light. Adding the binary phase grating pattern to the amplitude control of the ribbon elements of the MEMS phased-array 273 allows the 4f system 373 to also block side lobes (see FIG. 11B, 381 and 382) to prevent return light from retroreflectors from overwhelming sensors of the LIDAR system. FIG. 11C pictorially illustrates a use case where the LIDAR system 240 that incorporates the scanning system 250 receives return light from retroreflectors 361 on the road.

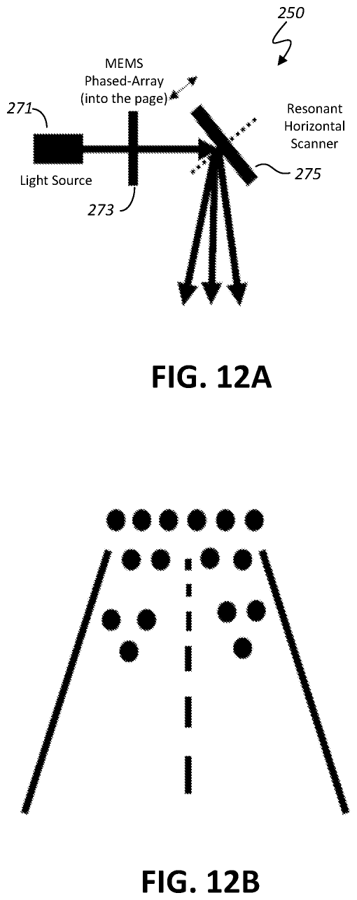

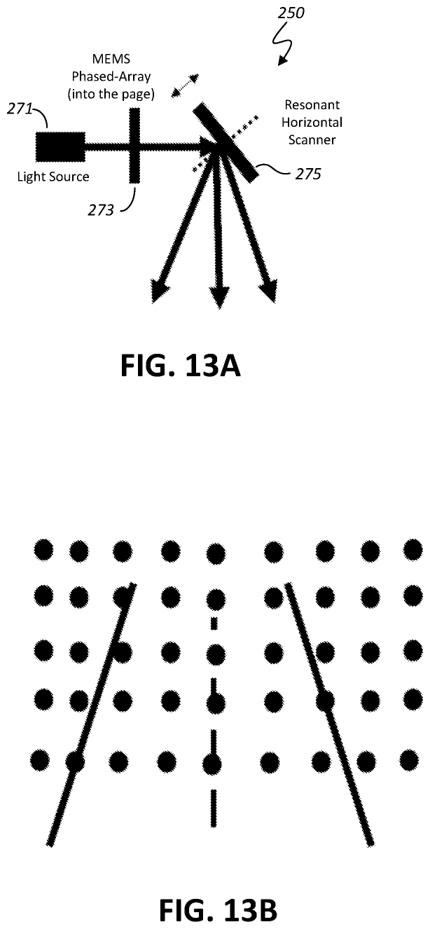

FIGS. 12A, 12B, 13A, and 13B pictorially illustrate the scanning system 250 being configured to adjust horizontal FOV for different driving conditions, in accordance with embodiments of the present invention. In FIGS. 12A and 13A, the MEMS phased-array 273 of the scanning system 250 is disposed into the page of the figure. The light source 271 generates coherent light that is steered in the vertical plane by the MEMS phased-array 273 and scanned in the horizontal plane by the resonant horizontal scanner 275. Return light from the far field scene is captured by the detectors 279 (see FIG. 5; not shown in FIGS. 12A, 12B, 13A, and 13B), which may be a 1-D detector array or a 2-D detector array. The resolution of the scanning system 250 is determined by the resolution of the MEMS phased-array 273 and the system numerical aperture.

FIG. 12A depicts the resonant horizontal scanner 275 with the amplitude of its FOV being adjusted symmetrically to be narrow for high speed driving, such as on freeways. FIG. 12B shows high resolution point clouds (depicted as dots), which are due to the narrower horizontal FOV. FIG. 13A depicts the resonant horizontal scanner 275 with the amplitude of its FOV being adjusted symmetrically to be wider for city driving or where there are many obstacles. FIG. 13B shows lower resolution point clouds due to the wider horizontal FOV. It is to be noted that resonant scanners in general suffer from inertia, and so typically will slow down while turning.

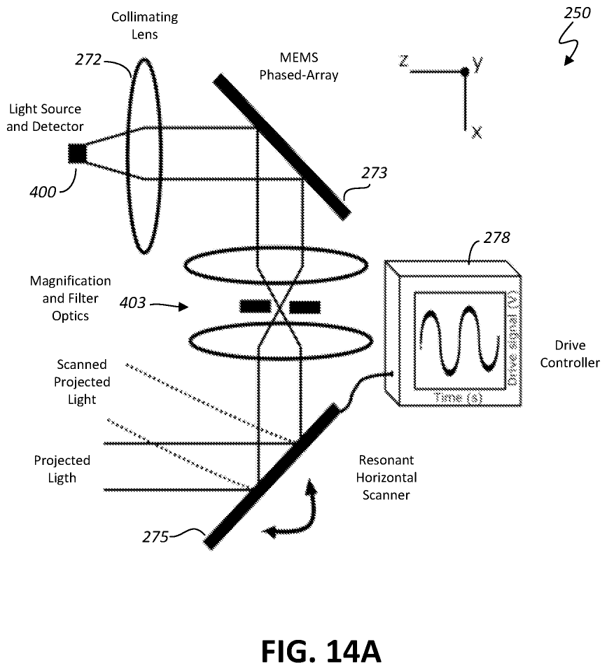

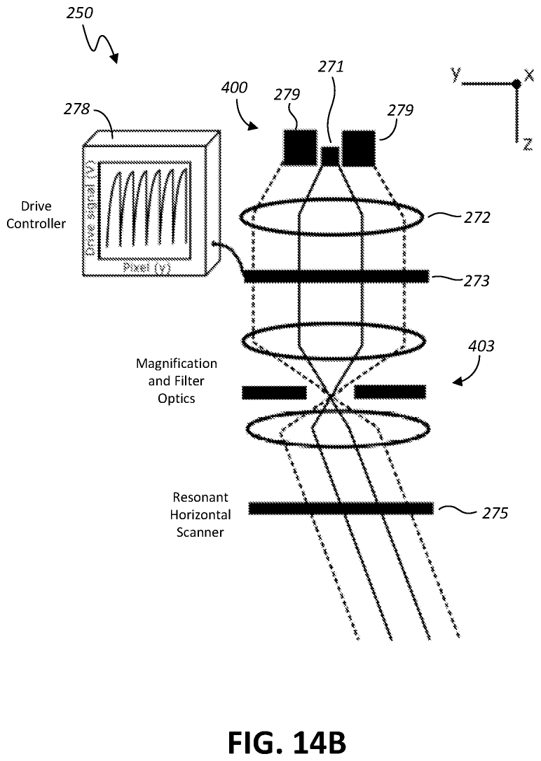

The scanning system 250 may be configured for monostatic, bistatic, or other detector configuration. FIGS. 14A and 14B are schematic diagrams of the scanning system 250 configured for monostatic configuration, in accordance with an embodiment of the present invention. In FIGS. 14A and 14B, the light source 271 and the detectors 279, which are collectively labeled as “400”, are disposed in the same general location. Accordingly, both the projected light and the return light share the same optics. The illumination optics 272 comprises a collimating lens. Magnification and filter optics 403 (e.g., 4f system) serve as relay and filter optics.

In FIG. 14A, the drive controller 278 drives the resonant horizontal scanner 275 with a sinusoidal drive signal, and drives the MEMS phased-array 273 to perform random access pointing of the projected light as previously described. FIG. 14A shows the nominal (depicted as a solid line) and scanned (depicted as a dashed line) projected light.

FIG. 14B shows the return light (depicted as dashed line) and projected light (depicted as solid line) sharing the same optics in monostatic configuration. The drive controller 278 drives the MEMS phased-array 273 to steer the return light toward the detectors 279 and to reject out of plane light. The MEMS phased-array 273 is configured to have a suitably large aperture to ensure that return light is collected by one or more detectors 279 that are disposed directly adjacent to the light source 271.

Because the return light and projected light both pass through the magnification and filter optics 403, any magnification of FOV angle will similarly match the FOV of the MEMS phased-array 273 to the system FOV at the expense of a smaller system aperture. This limitation of monostatic configuration is overcome by bistatic configuration. In bistatic configuration, the light source and detector are not adjacent to each other, requiring the return light to be directed toward the detector.

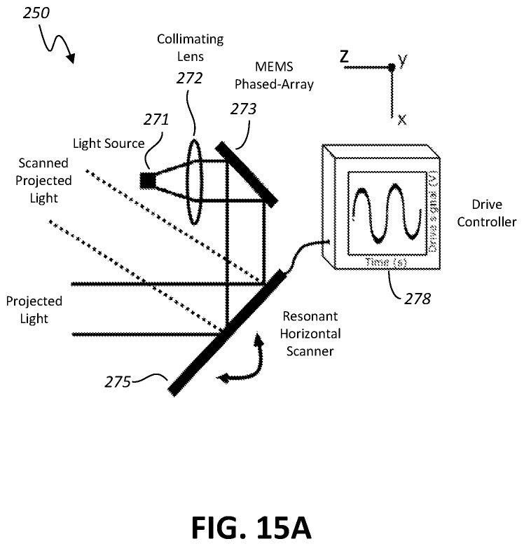

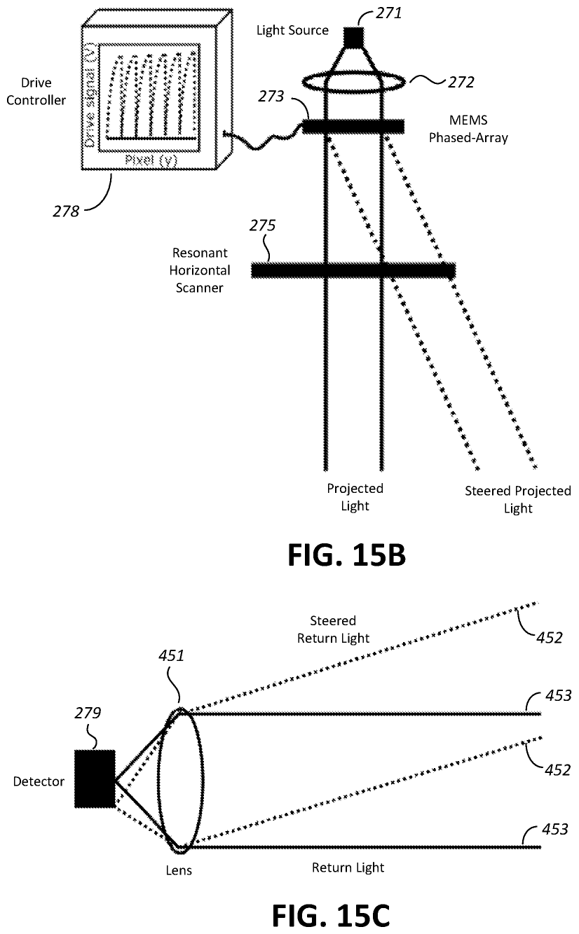

FIGS. 15A, 15B, and 15C are schematic diagrams of the scanning system 250 configured for bistatic configuration, in accordance with an embodiment of the present invention. In FIGS. 15A, 15B, and 15C, the illumination optics 272 comprises a collimating lens. In contrast to the monostatic configuration, the path of the return light does not need magnification and is separate from that of the projected light. This allows the MEMS phased-array 273 to have a larger aperture.

In FIG. 15A, the drive controller 278 drives the resonant horizontal scanner 275 with a sinusoidal drive signal, and drives the MEMS phased-array 273 to perform random access pointing of the projected light as previously described. FIG. 15A shows the nominal (depicted as solid line) and scanned (depicted as dashed line) projected light as per scanning by the resonant horizontal scanner 275. FIG. 15B shows the nominal (depicted as solid line) and steered (depicted as dashed line) projected light as per steering by the MEMS phased-array 273.

FIG. 15C shows the detector 279 in bistatic configuration, receiving the nominal (depicted as solid line) and steered (depicted as dashed line) return light as per return steering by the MEMS phased-array 273. A collection lens 451 is situated near but not coaxial to the projection system. The collection lens 451 either collects the entire far field scene onto a single detector or images onto a detector array.

As can be appreciated, the monostatic and bistatic send and receive configurations described herein may also be used in the orthogonal orientation, such that the MEMS phased-array 273 is steering in the horizontal dimension.

In one embodiment, a LIDAR system does not include a separate resonant horizontal scanner. In the embodiment, the MEMS phased-array performs both vertical and horizontal scanning. The embodiment provides a higher frame rate at the cost of larger beam divergence, and requires either imaging the far field onto a 2-D detector array or imaging the far field horizontally and compressing the vertical component onto a 1-D detector. In the latter case, the horizontal resolution is determined by the number of horizontal pixels in the 1-D detector, and the vertical resolution is determined by the resolution of the MEMS phased-array. The detectors in the embodiment may be arranged in monostatic or bistatic configuration.

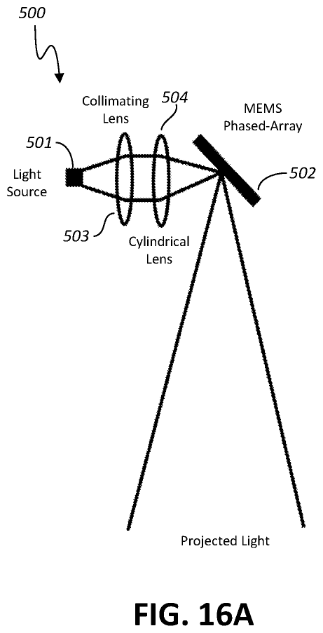

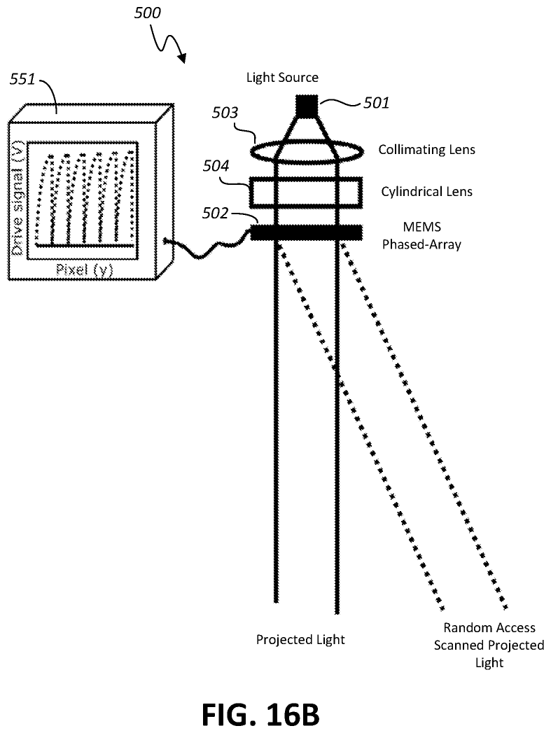

FIG. 16A is a schematic diagram of a scanning system 500, in accordance with an embodiment of the present invention. In FIG. 16A, coherent light from a light source 501 is collimated by lens 503 (e.g., spherical lens) and then concentrated by a cylindrical lens 504 onto a MEMS phased-array 502 (e.g., 1-D phased-array 110 of FIG. 1) to create a line beam that will illuminate the entire horizontal FOV. There is no separate horizontal scanner in the scanning system 500.

FIG. 16B shows the vertical axis of scanning system 500. Coherent light from the light source 501 is collimated by lens 503 to fill the MEMS phased-array 502 while being unaffected in this axis by the cylindrical lens 504 so that the beam remains collimated in the far field. The MEMS phased-array 502 is driven by a drive controller 551 to point the line beam along the desired vertical angle, creating vertical discrimination for LIDAR methods. However, the line beam does not allow for horizontal discrimination as with the collimated spot resonant scanned approach, and therefore the bistatic receiver must provide the horizontal discrimination, as with flash LIDAR or Time of Flight Camera approaches.

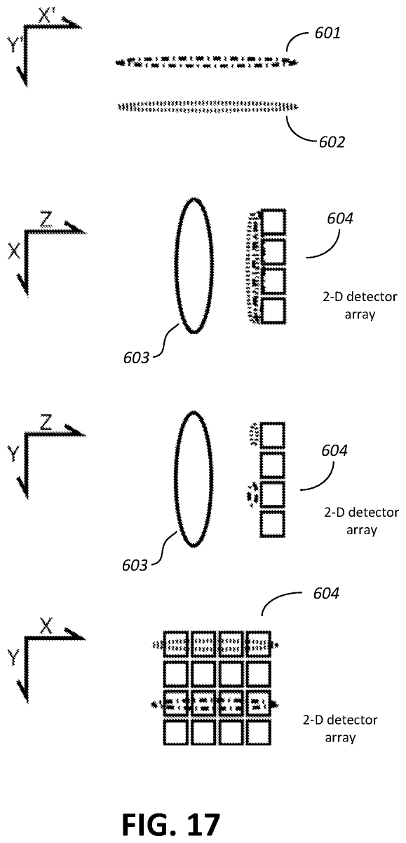

FIGS. 17-19 schematically illustrate receiver configurations that may be employed in the scanning system 500, in accordance with embodiments of the present invention.

In FIG. 17, a dash line (see FIG. 17, 601) represents a first scanning pattern and a dotted line (see FIG. 17, 602) represents a second scanning pattern that are projected onto the far field scene. Receiving optics 603 comprise a spherical imaging lens that images the corresponding return light of the scanning patterns onto a 2-D detector array 604. Return light is imaged onto the 2-D detector array 204 as in conventional camera imaging.

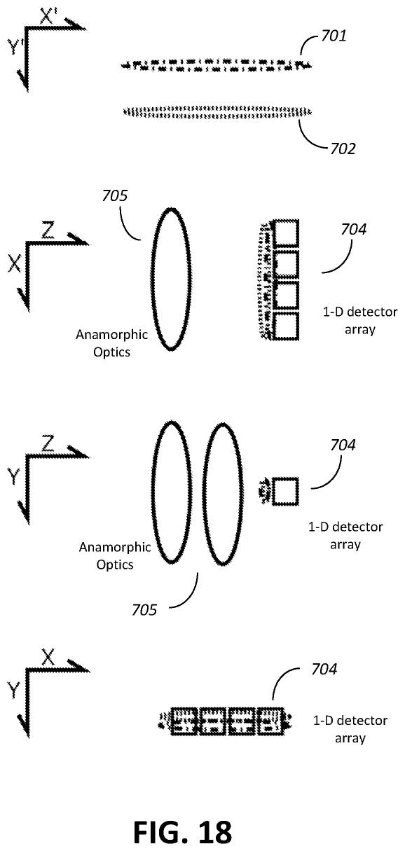

In FIG. 18, a dash line (see FIG. 18, 701) represents a first scanning pattern and a dotted line (see FIG. 18, 702) represents a second scanning pattern that are projected onto the far field scene. Corresponding return light of the first and second scanning patterns pass through anamorphic optics 705. The anamorphic optics 705 images horizontal information of the return light as normal onto a 1-D detector array 704, while compressing the vertical information of the return light onto the 1-D detector array 704. Vertical information discrimination is achieved by the pointing information from the MEMS phased-array. That is, vertical information of the return light may be determined based on the timing and pointing of the projected light as steered by the MEMS phased-array in accordance with drive signals from the drive controller.

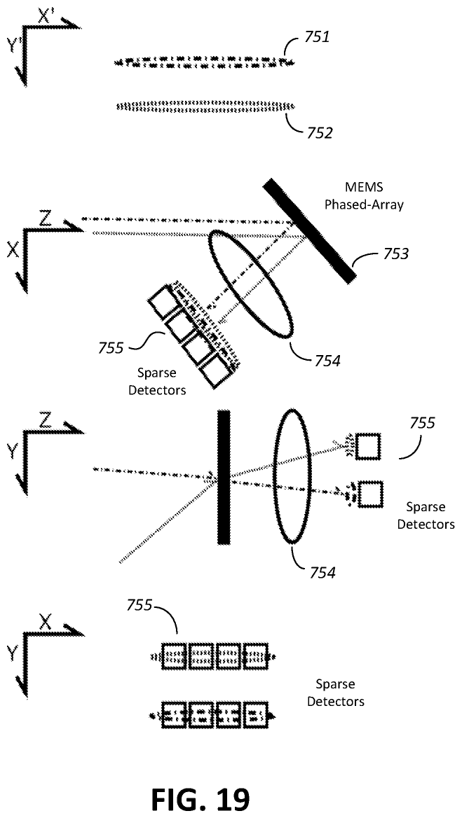

In FIG. 19, a dash line (see FIG. 19, 751) represents a first scanning pattern and a dotted line (see FIG. 19, 752 represents a second scanning pattern that are projected onto the far field scene. A MEMS phased-array 753 (e.g., 1-D phased-array 110 of FIG. 1), which is also used for both horizontal and vertical scanning of the projected light, steers the corresponding return light onto sparse detectors 755 by way of receiving optics comprising a spherical lens 754. The spherical lens 754 is used in a simple Fourier imaging configuration; the spherical lens 754 is placed one focal distance past the MEMS phased-array 753 and the sparse detectors 755 are placed one focal distance past the spherical lens 754. The sparse detectors 755 comprise 1-D detector arrays that are sparsely arranged, i.e., the detectors 755 do not have as much pixel sensors as a normal 2-D detector arrays. For example, there may be at least a pixel width separating adjacent 1-D detector arrays, and in most embodiments the number of detector rows will be less than 10 as opposed to the hundreds required for 2-D detector arrays. The gap between 1-D detector arrays in the sparse detectors 755 is not a major limitation because the MEMS phased-array 753 can be driven to steer return light onto particular detectors in the sparse detectors 755.

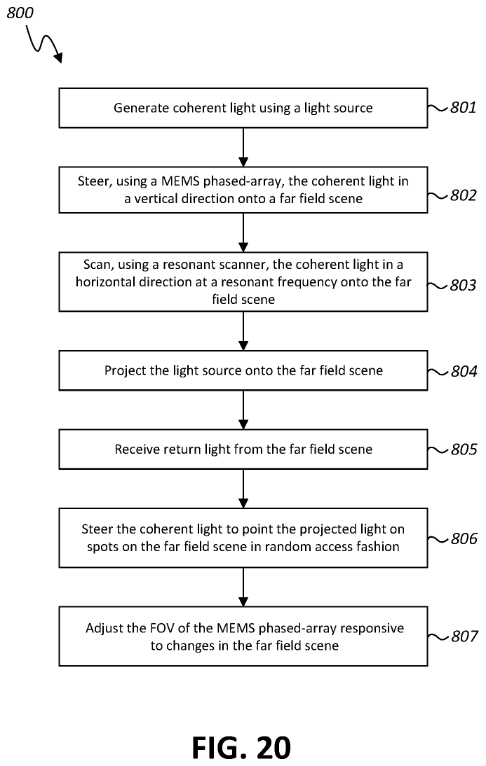

FIG. 20 is a flow diagram of a method 800 of operation of a LIDAR system, in accordance with an embodiment of the present invention.

In step 801, a coherent light (e.g., a laser) is generated by a light source.

In step 802, the coherent light from the light source is steered, using a MEMS phased-array, in a vertical direction onto a far field scene. The MEMS phased-array may comprise a ribbon-type SLM with electrostatically actuated ribbons.

In step 803, the coherent light from the light source is scanned, using a resonant scanner, in a horizontal direction at a resonant frequency onto the far field scene. The resonant scanner may be a resonant mirror scanner.

In step 804, the coherent light steered by the MEMS phased-array in the vertical direction and scanned by the resonant scanner in the horizontal direction is projected onto the far field scene.

In step 805, return light is received from the far field scene. The return light may be received by one or more photodetectors in monostatic configuration where the light source and the photodetectors are adjacent or in bistatic configuration where the light source and the photodetectors are not adjacent. In the bistatic configuration, the MEMS phased-array steers the return light to the photodetectors.

In step 806, the MEMS phased-array steers the coherent light from the light source to point the projected light on the far field scene in random access fashion. That is, the MEMS phased-array steers the coherent light such that the projected light is pointed from a first spot directly onto a second spot without necessarily having to point to one or more intervening spots on the far field scene between the first and second spots.

In step 807, the field of view of the MEMS phased-array is adjusted responsive to detected changes in the far field scene. For example, the field of view of the MEMS phased-array may be adjusted upwards in response to detecting an incoming hill.

While specific embodiments of the present invention have been provided, it is to be understood that these embodiments are for illustration purposes and not limiting. Many additional embodiments will be apparent to persons of ordinary skill in the art reading this disclosure.

What is claimed is:

1. A light detection and ranging (LIDAR) system comprising:
a light source that is configured to generate a light beam;
a micro-electro-mechanical system (MEMS) phased-array that is configured to steer the light beam in a vertical direction onto a far field scene;
a resonant scanner that is that is configured to scan the light beam in a horizontal direction at a resonant frequency onto the far field scene; and
a detector that is configured to receive return light from the far field scene.

2. The LIDAR system of claim 1, wherein the detector comprises a two-dimensional (2-D) array of photodetectors.

3. The LIDAR system of claim 1, wherein the MEMS phased-array comprises a ribbon-type spatial light modulator (SLM), the ribbon-type SLM comprising a plurality of electrostatically actuated ribbons as modulation elements.

4. The LIDAR system of claim 1, wherein the resonant scanner comprises a resonant mirror scanner.

5. The LIDAR system of claim 1, wherein the detector is disposed adjacent to the light source in monostatic configuration.

6. The LIDAR system of claim 1, wherein the detector is not disposed adjacent to the light source in bistatic configuration.

7. The LIDAR system of claim 6, further comprising a 4f system disposed in a light path between the MEMS phased-array and the resonant scanner.

8. The LIDAR system of claim 6, wherein the MEMS phased-array is configured to steer the return light onto the detector.

9. The LIDAR system of claim 1, wherein the LIDAR system is in a vehicle.

10. The LIDAR system of claim 1, wherein the LIDAR system is in an aircraft.

11. A method of operation of a light detection and ranging (LIDAR) system, the method comprising:
generating a coherent light from a light source;
steering, by a micro-electro-mechanical system (MEMS) phased-array, the coherent light in a vertical direction onto a far field scene;
scanning, by a resonant scanner, the coherent light in a horizontal direction onto the far field scene at a resonant frequency; and
receiving return light from the far field scene.

12. The method of claim 11, further comprising:
adjusting a field of view (FOV) of the MEMS phased-array.

13. The method of claim 12, wherein the FOV of the MEMS phased-array is adjusted in response to detecting a change in the far field scene.

14. The method of claim 13, wherein the FOV of the MEMS phased-array is adjusted upwards in response to detecting that a vehicle that incorporates the LIDAR system is approaching a hill.

15. The method of claim of claim 11, wherein steering, by the MEMS phased-array, the coherent light in the vertical direction onto the far field scene comprises:
projecting the coherent light onto the far field scene as projected light; and
steering the coherent light in the vertical direction to point the projected light from a first spot on the far field scene directly to a second spot on the far field scene without pointing the projected light on one or more spots on the far field scene that are between the first and second spots.
